(19) United States
(12) Patent Application Publication
(10) Pub. No.: US 2006/0140370 A1
(43) Pub. Date: Jun. 29, 2006

(54) Monitoring resource usage in a network

(75) Inventors: Vikas Agarwal, New Delhi (IN); Neeran M. Karnik, New Delhi (IN); Arun Kumar, New Delhi (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/025,347

(22) Filed: Dec. 29, 2004

(51) Int. Cl. H04M 15/00

(52) U.S. Cl. 379/114.28

(57) ABSTRACT

A system, method and computer program product provide a generic accounting management system that can be configured at runtime to monitor and meter resources connected to a network. An accounting manager monitors and meters resource usage on the network. One or more agents collect usage data from one or more managed resources connected to the network and report this usage data to the accounting manager. The accounting manager stores the usage data in an accounting data schema. An administration manager supplies network-specific configuration information to the accounting manager at runtime such that the accounting manager and the accounting data schema are configured to the specific resource usage characteristics of the network. The accounting data schema comprises monitoring, metering and accounting classes which are populated at runtime based on the network-specific configuration information.

### FIELD OF THE INVENTION

The present invention relates to network management and, more particularly, to a system, method and computer program product for building a generic accounting management system to monitor resource usage data of network infrastructures.

### BACKGROUND

Various internet-based services consume resources in the service provider's computer infrastructure while servicing client requests. These resources may be heterogeneous, and distributed across the service provider's infrastructure. The client is accountable for the total resource usage and/or service usage resulting from its request. Thus the service provider's management infrastructure needs to actively monitor the consumption of resources/services, and assign it proportionately to the client requests that were serviced. In order to do that the management infrastructure needs a mechanism to be able to describe, store and query monitored usage data, and also the information pertaining to metering and accounting of that usage.

The Internet Engineering Task Force's Authentication, Authorization and Accounting (AAA) Working Group has defined a draft standard for accounting as applied to network access, named the Diamond Base Protocol. The Diameter Base Protocol defines the requirements for accounting attributes and the record format. In the Protocol's architecture a service element (i.e. a network element) provides service to the consumers and sends usage events to an accounting server. A usage event contains the actual usage values. However, the Diameter Base Protocol does not allow new types of accounting records and metrics to be defined at runtime.

Additionally, the Internet Protocol Detail Record organisation (IPDR) has been instrumental in defining standards to specify the formats of data records (i.e. accounting records) which can cater to the requirements of the telecommunications industry taking into account the emergence of non-voice based services. The IPDR specification defines a framework, interfaces and protocols for exchange of usage data among service elements and consumers of such data. The generic IPDR record is an abstract specification, and the specific metrics for each application must be defined separately in standard schemas.

It is with these issues in mind that the present invention has been made.

### SUMMARY

In the monitoring and metering resource usage in a network an administration manager. supplies network-specific configuration information to an accounting manager at runtime. One or more agents collect usage data from one or more managed resources connected to the network and report this collected usage data to the accounting manager.

The accounting manager meters usage data of the one or more managed resources by being configured at runtime to the specific resource usage characteristics of the network based on the network-specific configuration information. The accounting manager has an accounting data schema which has monitoring, metering and accounting classes that are populated at runtime based on the network-specific configuration information.

A database module stores an accounting data schema which can be configured at runtime based on the network-specific configuration information. The accounting data schema has monitoring, metering and accounting classes which can be populated at runtime. One or more agent modules collect usage data from one or more managed resources connected to the network and report this collected usage data to the accounting manager module.

The data schema has a unit of work definition class having an association with a unit of work value class; a base metric definition class having associations with a composite metric definition class and a base metric value class; a monitoring record definition class having associations with a monitoring record value class, the unit of work definition class and the base metric definition class; and a metering record definition class having associations with a metering record value class, itself, the base metric definition class and the unit of work definition class.

### BRIEF DESCRIPTION OF THE DRAWINGS

FIG. 1 is a schematic representation of a resource accounting system;

FIG. 2 shows a modified Common Information Model (CIM) metric schema;

FIG. 3 shows a metering and accounting schema;

FIG. 4 is a schematic representation of an implementation of the system of FIG. 1; and

FIG. 5 is a schematic representation of a computer system suitable for performing the techniques described herein.

### DETAILED DESCRIPTION

Introduction

In the context of the present specification, the term “deployed” is intended to denote the time at which a system or a computer program is installed and made ready to run. The term “runtime” denotes the time between the start and the end of a program execution.

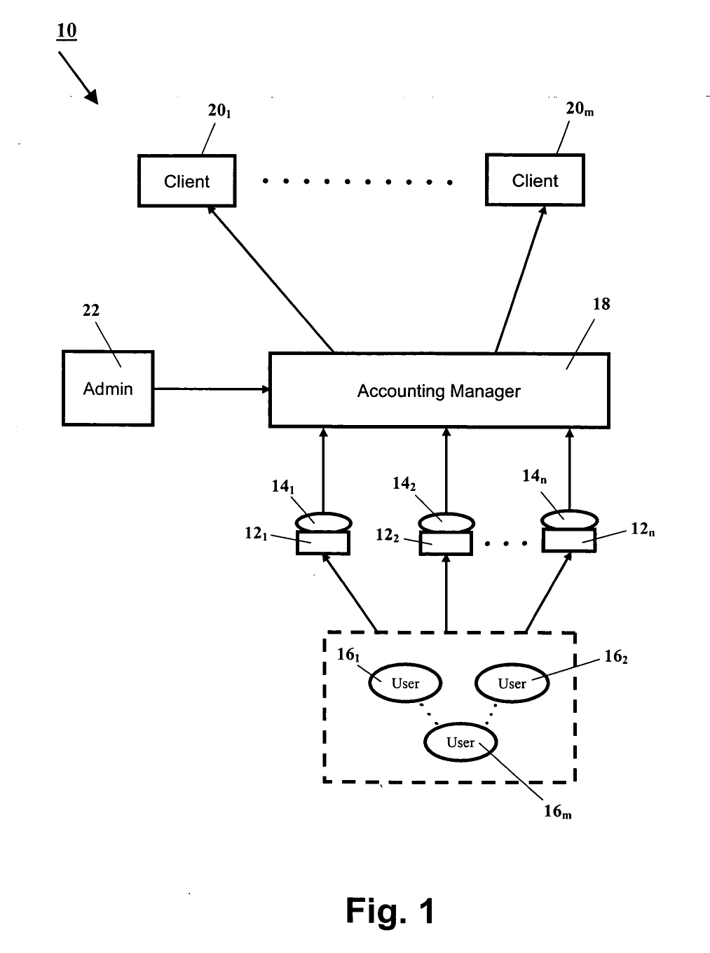

FIG. 1 shows a resource accounting system architecture 10. A plurality of managed objects 12₁, 12₂, . . . , 12ₙ are provided, and can be either hardware elements (such as printers or memory) or software entities (such as an application server or a web service). Each object 12 has an associated agent 14₁, 14₂, . . . , 14ₙ. A number of users 16₁, 16₂, . . . , 16ₘ access the resource provided by one or more of the objects 12, from time to time.

The agent 14 collects metrics from the respective managed object 12, and provides those metrics to an accounting manager 18. A plurality of clients 20₁, 20₂, . . . , 20ₘ are served by the accounting manager 18. The clients 20 use an Application Programming Interface (API) to query and receive accounting metrics collected by the accounting manager 18. The accounting manager 18 stores and manages an underlying data model schema that captures the relationships between different kinds of metrics and their associations with corresponding units of work.

An administration module 22 configures the accounting manager 18 at runtime by supplying it with domain-specific configuration information such as the units of work that need to be accounted for and the specific metrics that need to be collected and/or computed for those units of work. Accordingly, a domain-specific instance of the generic accounting model may be created, and is used by the accounting manager 18 to provide domain-specific accounting functionality. The configuration information is also used to derive accounting metrics differing from those supplied by the agents 14. These derived metrics are supplied to the clients 20.

Underlying Data Model Schema

Referring again to FIG. 1, the accounting manager 18 has an underlying data model schema that is based upon the Common Information Model (CIM) of the Distributed Management Task Force (DMTF) (version 2.4 of August 2000, available from http://www.dmtf.org/standards/documents/CIM/DSP0111.pdf and incorporated herein by reference).

The CIM management model consists of a large number of classes that capture the characteristics of various system entities. The model has three conceptual layers: the Core model, the Common models, and the Extension models. The Common models represent management information specific to a domain, but independent of any specific technology. The CIM metrics schema is one of the CIM Common models.

The CIM metrics schema models application performance by representing response time for a unit of work (class=Unit Of Work). To specify metrics that are independent of any unit of work but related to a managed element, two additional classes are employed: BaseMetricDefinition and BaseMetricValue.

Modified CIM metric schema

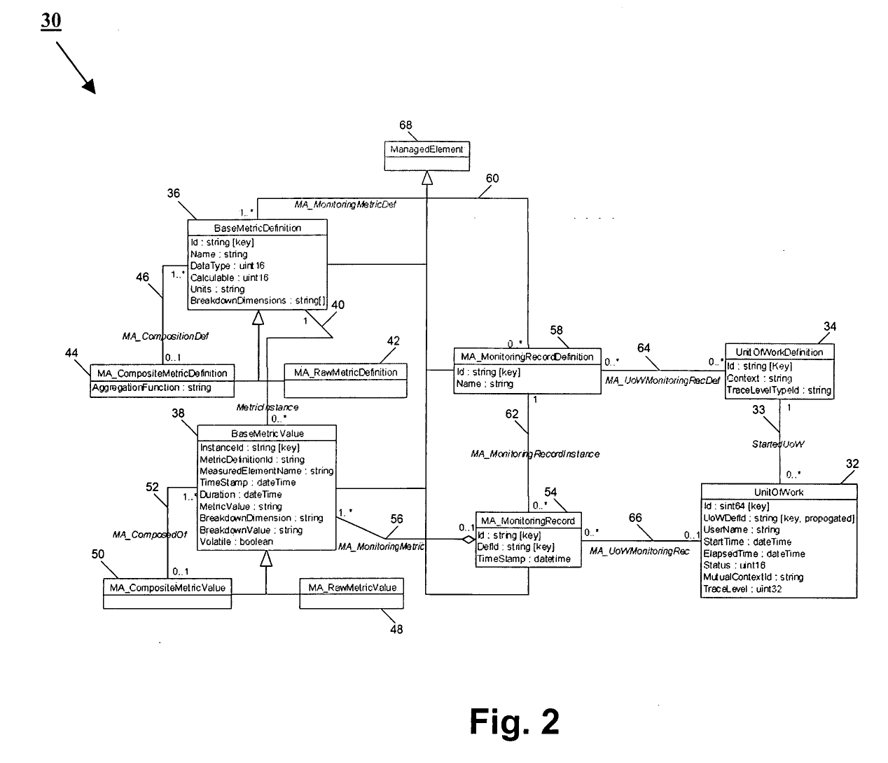

FIG. 2 shows a modified CIM metric schema 30. The boxes represent different classes (consisting of class name and attributes), and the interconnecting lines represent associations between classes.

The UnitOfWork class 32 represents an instance of a transaction or work that is either in progress or has already completed. The UnitOfWork class 32 it contains the response time (“Elapsed Time”) and execution status (“status”) of the work, and it has a corresponding UnitOfWorkDefinition class 34, which gives additional information about the type of unit of work. Various types of work units can be represented using the UnitOfWorkDefinition class 34 and the UnitOfWork class 32. For instance, for a computer server, a unit of work may be delimited by the start and end of execution of a job. For a web service, a method invocation and its response could delimit a unit of work. The UnitOfWork class 32 is associated with the UnitOfWorkDefinition class 34 by a StartedUoW association 33.

The BaseMetricDefinition class 36 defines the properties of a metric, such as its unit of measurement, data type, etc, and is therefore used to represent metrics such as CPU utilization, memory consumption and so on.

An actual value of the metric is modeled by the BaseMetricValue class 38. Various values of a metric at different points of time are represented using instances of the BaseMetricValue class 38, all of which are associated with the same definition via the MetricInstance association 40. The metric definition helps abstract the common properties of a metric into a separate class and enables queries such as “Fetch all metrics of a particular type”.

Raw and Composite Metrics

The BaseMetricDefinition class 36 is associated with two classes: the MA_RawMetricDefinition class 42 and MA_CompositeMetricDefinition class 44 derived from it. The MA_RawMetricDefinition class 42 is used to model measured data from managed elements such as CPUConsumed, whereas the MA_CompositeMetricDefinition class 44 is used to model computed metrics such as TotalCPUConsumed. Representing raw metric definition as a class derived from the BaseMetricDefinition class 36 simplifies the querying capability. The management application can issue a query “Retrieve all raw metric definitions”. A composite metric is composed of several metrics (raw or other composite metrics), and this situation must be captured in its definition. Therefore, the MA_CompositeMetricDefinition class 44 is associated with the BaseMetricDefinition class 36 via the MA_CompositionDef association 46. The MA_CompositeMetricDefinition class 44 has a member field (“Aggregation Function”) that describes the aggregation function required to create a composite metric from other metrics. An aggregation function could use summation, averaging or any other function to combine the metric values.

The BaseMetricValue class 38 is associated with two classes: the MA_RawMetricValue class 48 and MA_CompositeMetricValue class 50 derived from it. The MA_ComposedOf association 52 gives the actual values of base metrics (raw or other composite metrics) that are used to compute the composite metric.

Monitoring Record

Monitoring activity is fundamental to management systems. It involves collection of meaningful data that represents the state of the entity being monitored. The CIM Metrics schema allows this data to be captured through the BaseMetricDefinition class 36 and the BaseMetricValue class 38. However, a BaseMetricValue class 38 can at best represent a particular aspect of the overall state. To enable capture of state, a representation is required that can encapsulate these individual pieces of state data and make the relevant state available as a single entity. For example, consider process accounting records logged by Unix™ systems, which contain the consumption of various resources by a process. Here, it is more convenient to represent all the metrics (such as CPU, memory and I/O usage) together in a record for a process and assign it a timestamp, instead of representing them separately and associating them all with a process. Sometimes it is a requirement of the application to retrieve all the metrics as a record or none at all. Moreover, for long-running processes the operating system can log this information at periodic intervals (called interval accounting) to keep track of its state. Hence, several such records can be logged for a process giving its state at various instants of time. This can be modeled with the notion of a monitoring record—an aggregation of one or more metrics (either raw or composite) such that the component metrics represent state observed within the boundaries of a specific period of time.

Monitoring information is captured in a MA_MonitoringRecord class 54 that represents the state of the transaction represented by a unit of work at an instant of time. It has a TimeStamp field that gives the time at which this state was measured, and it is related to its component metrics via the MA_MonitoringMetric aggregation 56. A MA_MonitoringRecordDefinition class 58 describes the content of a monitoring record. The component metric definitions are specified through the MA_MonitoringMetricDef association 80. A MA_MonitoringRecord class 54 instance is related to its definition through the MA_MonitoringRecordInstance association 62. A unit of work definition is associated with its monitoring record definition via a MA_UoWMonitoringRecDef associated 64. Similarly, a unit of work is associated with its monitoring record via MA_UoWMonitoringRec association 64.

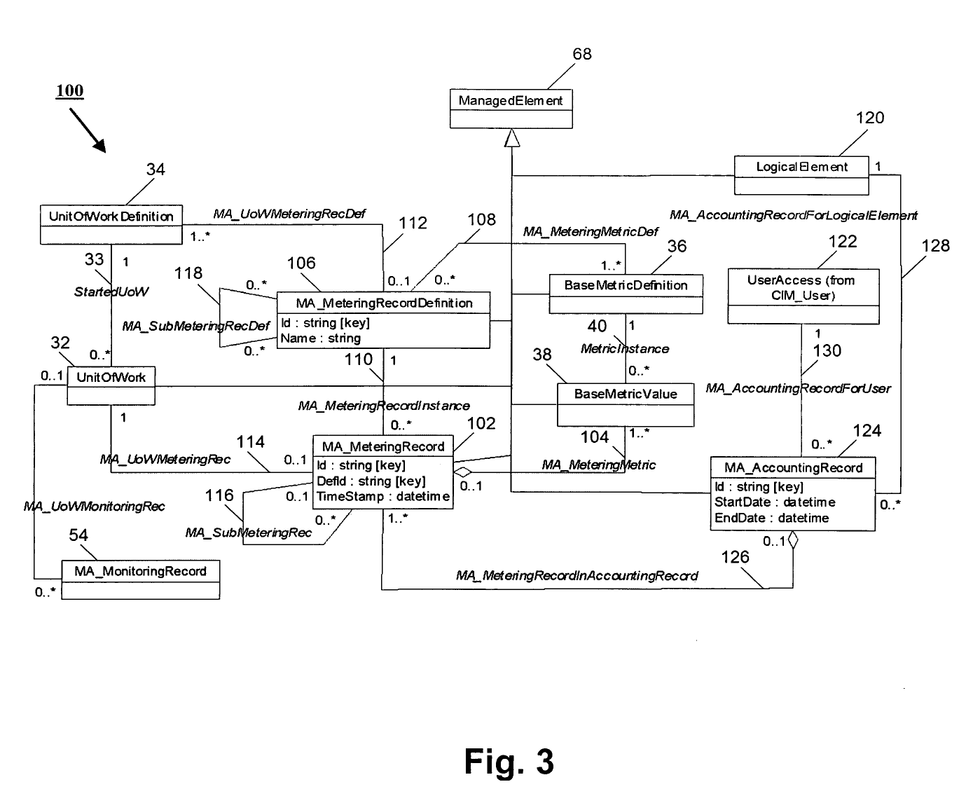

The notion of a monitoring record, as described above, prevents non-standard modeling decisions that programmers currently are forced to make. The definition of a distributed statistic record is modelled in the standard way, i.e. by associating it to the corresponding metric definitions represented by MetricDefinition class. However, the value of a distributed statistic record is modelled by including the desired metric values as attributes of a class derived from UnitOfWork instead of using the UoWMetric association. This modeling decision is because the intended usage of unit of work data requires either retrieval of the entire record (with all its metrics) or no record at all. All the classes in the data schema are subclasses of the ManagedElement class 68, as indicated with the triangle symbol in FIG. 2 (and FIG. 3).

Metering and Accounting Schema

Referring now to FIG. 3, a metering and accounting schema 100 is shown. The schema 100 introduces three new classes (and various associations between them and existing classes shown in FIG. 2).

Representing Metering Information

Metering information is captured in a MA_MeteringRecord class 102 that represents the information needed to measure the usage of a unit of work. The metering record is an aggregation of metering-specific metrics (raw or composite). These metrics are derived from the metrics contained in the monitoring records of the UnitOfWork class 32 under consideration. It is important to observe that a unit of work may have several monitoring records representing its state at different instants of time, but it will have only one metering record giving its usage. Moreover, a monitoring record may contain other metrics that are used for purposes, such as capacity planning and fault monitoring, apart from those used in metering.

A metering record is related to its component metrics via a MA_MeteringMetric aggregation 104. A MA_MeteringRecordDefinition class 106 describes the contents of a metering record. The component metric definitions are captured through the MA_MeteringMetricDef association 108. The MA_MeteringRecordDefinition class 106 allows multiple types of metering records to be defined, which might vary for different UnitOfWorks. In the absence of the MA_MeteringRecordDefinition element, an abstract MA_MeteringRecord class would have to be defined and each time a new metering record has to be introduced for some LogicalElement, a new subclass of the abstract class would have to be created.

Each MA_MeteringRecord class 102 is associated with its definition via the MA_MeteringRecordInstance association 110. A unit of work definition is associated with its metering record definition via the MA_UoWMeteringRecDef association 112. Similarly, a unit of work instance (class 32) is associated with its corresponding metering record (class 102) via the MA_UoWMeteringRec association 114. A metering record may be associated with other metering record instances via the MA_SubMeteringRec association 116. This is because the CIM Metrics model includes composite UnitOfWorks; the metering record of a composite unit of work would be computed from the metering records of its component units of work. The use of the MA_SubMeteringRec association 116 enables the correlation of instances of metering records. Similarly, the metering record definition (class 106) of a composite UnitOfWorkDefinition class 34 is also associated with metering record definitions of its components via the MA_SubMeteringRecDef association 118. If UnitOfWork hierarchies are predefined then the MA_SubMeteringRecDef associated 118 can be used to express the anticipated relationship between the corresponding MA_MeteringRecordDefinitions 106. In this way, the model 100 allows precise specification of what constitutes the metering record of a composite unit of work. Observe that the MA_MeteringRecordDefinition class 106 of a UnitOfWork class 32 (composite or otherwise), once defined (i.e. instantiated), does not change irrespective of which SubUoWs finally compose to form the UnitOfWork.

Representing Accounting information

Unlike metering, which is tied to a unit of work, accounting involves two participants—a producer and a consumer. In the present schema 100 a LogicalElement class 120 represents the producer, and a consumer is the user who used that LogicalElement. The producer could be a resource that is consumed or a service that offers some functionality to its users both of which are modeled as LogicalElements in CIM. A user is represented by a UserAccess class 122 from the CIM User schema. The consumption or use of a LogicalElement is modeled by a unit of work. Therefore, the usage resulting from the execution of a unit of work needs to be assigned to the user who is responsible for initiating it.

An MA_AccountingRecord class 124 is introduced to represent the accounting information that needs to be captured. The class 124 is defined as an aggregation of metering records corresponding to one or more UnitOfWorks that were executed on behalf of a user. An MA_AccountingRecord class 124 exists in the context of a LogicalElement class 120 and a user of that logical element. The user could be a person, or another LogicalElement such as an application or service. In the latter case, the user or owner of the application/service would have to be represented as the consumer associated with the accounting record. An MA_AccountingRecord class instance is associated with its component metering records via the MA_MeteringRecordInAccountingRecord aggregation 126. The MA_AccountingRecordForLogicalElement association relates multiple instances of MA_AccountingRecord class 124 to an instance of LogicalElement class 120. This association 28 specifies to which instance of LogicalElement those MA_AccountingRecords belong. Similarly, all the accounting records are associated with their corresponding users via the MA_AccountingRecordForUser association 130.

Unlike an accounting record, the present schema 100 defines a MA_MeteringRecord in the context of a UnitOfWork and not for a LogicalElement or a ManagedElement because it is reasonable to assume that something that can be metered should have a start-time and an end-time (otherwise the metrics obtained represent monitoring information rather than metering information). Thus, anything that has to be metered can be expressed as a UnitOfWork. A UnitOfWork, in turn, is associated with a LogicalElement and therefore metering of an activity of a LogicalElement can be represented in the schema.

Implementation Embodiments

Referring again to FIG. 1, three embodiments of this architecture 10 may be implemented to build a generic accounting management system. These are:
1. The generic model is implemented in application code;
2. The generic model is implemented in middleware; and
3. The generic model is implemented partially in middleware and partially in application code.
   Application Code Implementation

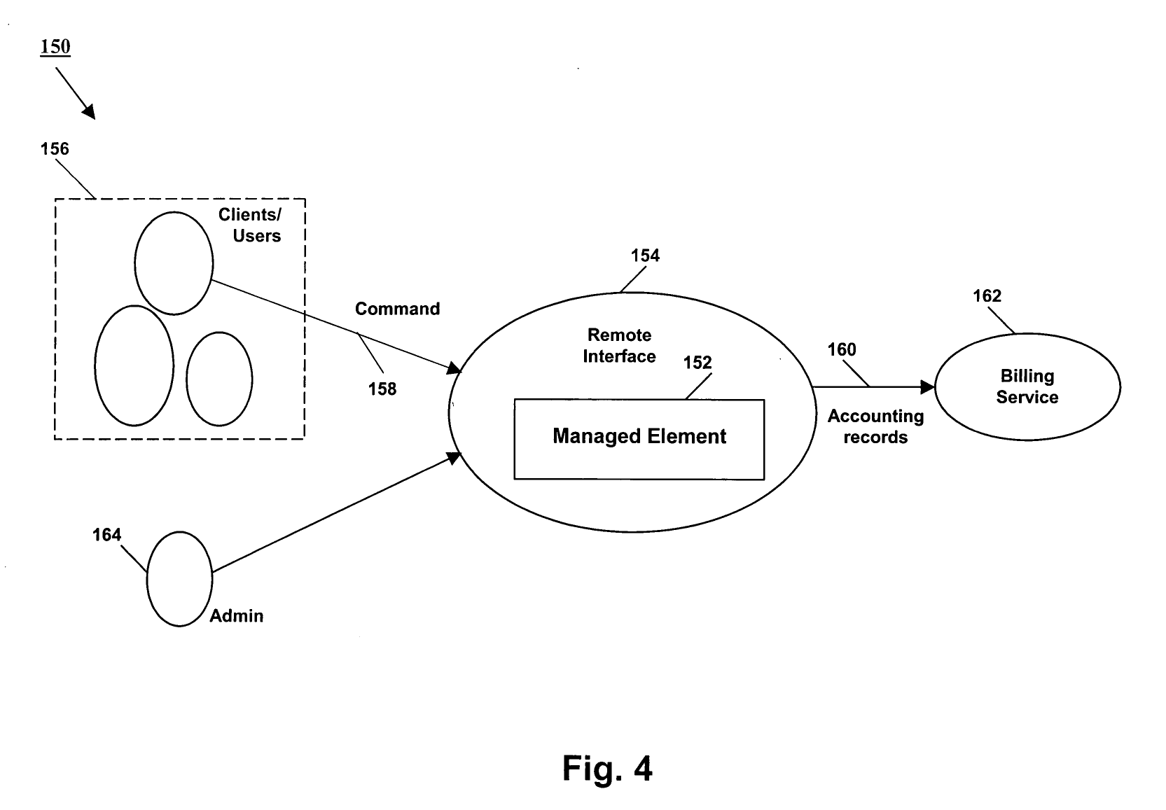

In the first embodiment, shown in FIG. 4, the application code (encapsulating a managed element 152 to be metered and accounted for) is implemented for the Accounting system 150. A remote interface 154 to a managed element 152 (e.g. a printer) is responsible for tracking the usage of the printer 152 by remote clients 156. The remote interface 154 is not restricted to only one managed element and may encapsulate any number of resources/services to be accounted for.

In this embodiment the remote interface 154 incorporates the functionality of the Accounting Manager 18 as shown in FIG. 1. A print command 158 represents the unit of work to be metered or accounted for. For each print command 158, an agent implemented inside the remote interface 154 collects basic metrics from the printer 152 such as user-id, pages printed, type of printout (color or black/white), single-sided or double sided, time taken, file name, location of file on disk etc. These metrics constitute the information that corresponds to a monitoring record of the printer 152.

From this information, metrics that are to be used for metering the usage of the printer 152 are then extracted, corresponding to a metering record of the accounting data model. These metrics may then be aggregated over various jobs of the remote clients 156 and reported in accounting records 160 and provided to a billing service client 162. The accountable usage metrics for the printer 152 may, for example, be <user-id, pages printed, type of pages, single sided or double sided>.

In this example, the application code of the software that exports the remote interface 154 to the printer 152 implements the semantics of the accounting data model. Since the various parameters of the data model such as unit of work, and monitoring parameters are hard coded into the application code (and therefore not configurable), the administration module 164 is not used to configure the remote interface 154. However, the administration module 164 may be used to configure the Accounting System 150 for element-specific or user-defined metrics, if desired. For example, the Accounting System 150 may be configured by the administration module 164 to monitor the ‘number of requests’ or the ‘number of pages’ for the printer 152 and use these as chargeable usage metrics.

Middleware Implementation

Referring again to FIG. 1, in a preferred embodiment, the Accounting Manager 18 and the related data model schema are implemented using middleware technology such as web services, Java 2 Platform Enterprise Edition (J2EE) or CIM Object Manager (CIMOM). The Accounting Manager 18 stores and manages the underlying data model schema that relates to the accounting aspects of the managed system, as depicted in FIG. 2 and FIG. 3. The data model schema may also relate to other (non-accounting) aspects of the managed system. These aspects are specified in the Core and Common models of the CIM and are pre-loaded in a CIM Object Manager (CIMOM).

Referring to the same print service example as above, the Administration module 22 may be used to configure the Accounting Manager 18 with the details of the data schema defining which metrics of the printer 12 constitute a monitoring record, a metering record and an accounting record.

The Administration module 22 specifies the configuration information for the printer 12 in the form of text files or through a Graphical User Interface (GUI) and typically loads this information into the Accounting Manager 18 at runtime. CIM Object Managers (CIMOMs) provide an Application Programming Interface (API) to enable the configuration information to be loaded into the Accounting Manager 18. One possible protocol to communicate the information from the Administration module 22 to the CIMOMs is specified by the Distributed Management Task Force (DMTF) as part of the Common Information Model (CIM) specification.

Based on the configuration information for the printer 12 supplied by the Administration module 22, classes in the data model schema are instantiated and values are assigned to the attributes of the instantiated domain-specific objects. These classes are identified by the inclusion of the word “Definition” at the end of their name. Examples of definition classes are shown in blocks 34, 36, 42, 44 and 58 in FIG. 2 and additionally in block 106 in FIG. 3.

An agent 14 collects basic metrics from a printer 12 and reports these to the Accounting Manager 18. On receipt of metrics from the agent 14, the accounting manager 18 creates appropriate monitoring record instances. Based upon these record instances and the model supplied by the administration module 22, the appropriate metering record and accounting record instances are also created. These are then made available to various client applications 20 such as a Billing Service application.

The agents 14 periodically collect metrics from the managed elements 12. These metrics are reported to the Accounting Manager 18 by creating object instances of the BaseMetricValue 38 class and associating these instances with the instances of the domain-specific BaseMetricDefinition 36 class that were loaded at runtime. Similarly, the agents 14 create instances of the MonitoringRecord class 54 and associate these instances with the instances of the domain-specific MonitoringRecordDefinition class 58, loaded at runtime.

Whenever a unit of work is completed, the agents 14 create an instance of the MeteringRecord class 102 and compute its metrics using the metrics available in the MonitoringRecord class 54 instances. These MeteringRecord instances conform, and are associated with the domain-specific MeteringRecordDefinition class 106 instances which were loaded at runtime. Periodically, the agents 14 trigger the creation of instances of the AccountingRecord class 124. An instance is created for each user 16 that uses the managed element 12.

Middleware/Application Code Implementation

Referring still to FIG. 1, in a third embodiment, a portion of the features of the accounting data model may be hard-coded into the application code while other features may be implemented using middleware technologies such as web services, J2EE, or CIMOM. For example, the agent 14 which undertakes the monitoring functionality of the Accounting Manager 18 may be implemented inside the application code whereas metering and accounting functionality may be implemented using an appropriate middleware technology.

Application of CIM Metering and Accounting Model

The schema 100 has applications in various management. scenarios such as capacity planning, charging customers, resource provisioning, analysis of usage patterns etc. The schema 100 can be used in three ways, as described above.

Other applications include:

Metering and Accounting for Composite E-Services

Composite e-services are those services which invoke other, simpler services to serve their clients, resulting in a service invocation hierarchy. This can be modeled by using UnitOfWork class for service invocations and SubUoW association to capture relationship with component services. Each service is autonomous and is registered with an Accounting Service to which it specifies its usage metrics. A meter, inside each service, uses local monitor data and/or application-level metrics to construct per-request usage in a partial metering record. The metering record is partial because it reports usage pertaining to that service alone and does not include the usage of underlying services. The partial metering record is sent to the Accounting Service, which creates the complete metering record of a request to a service by correlating its partial metering record with the corresponding complete metering records of the requests to underlying services. These complete metering records are aggregated into the account of the corresponding <client, service-provider> pair. This results in the generation of accounting records. The Billing module generates bills from these records by applying pricing functions.

An alternative implementation is to run a CIMOM in each service meter and a CIMOM in the accounting service. The CIMOMs in the service meters would make available monitoring records to various management applications. They would also act as CIM providers to the CIMOM in the accounting service for providing the metering records. The service meter CIMOMs provide those metering records by computing them from the monitoring records available with them.

Unix™ Accounting Utilities

Traditional Unix™ Accounting is based on the notion of a user account. Various accounting processes write different kinds of records such as connection-based, process-based, disk-based, printer-based and fee based records in their respective accounting logs. A runacct process uses this raw usage information and aggregates them on per user basis. A total accounting record is written at the end of the cycle summarizing the resource usage by different users. However, the accounting implementation is not compatible across Unix™ variants (such as AIX™, Linux™, HP-UX™ etc.) mainly due to the difference in ways of obtaining resource usage information. Another factor is that some non-standard resource usage metrics may be available on select Unix™ platforms. Accounting on Unix™ systems could be unified by making use of a standard management platform such as CIM and the schema proposed in this paper. Processes, disk accesses, printer jobs etc. could be modeled as UnitOfWorks. The CIM providers on each platform would implement platform-specific mechanisms to capture the records written into various accounting logs as MA_MonitoringRecords. Usage metrics relevant for charging could then be obtained from these monitoring records to construct MA_MeteringRecords. This may involve some aggregation of monitoring records that got constructed from interval accounting log entries. These metering records collected over a cycle can further be aggregated on per-user basis into MA_AccountingRecords. This scenario corresponds to the second approach described earlier in this section. In case of distributed systems, the computation of accounting records may be done on a management node outside of individual servers. In such a case, the metering records can be aggregated on the basis of some other parameter such as “hostname”. The CIM provider could append the hostname to each metering record thus avoiding a modification to current Unix™ implementations.

The generic modifications to the CIM metric schema proposed in the information model, i.e. composite metrics and monitoring records can be used in management applications other than accounting, such as SLA monitoring, capacity planning, fraud and intrusion detection etc.

Computer Hardware

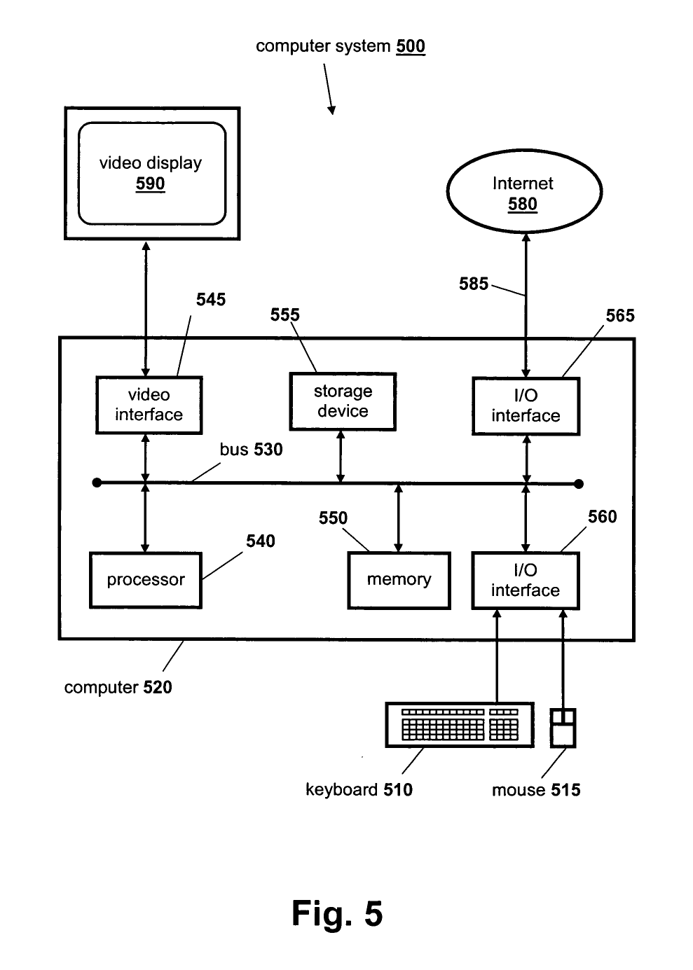

FIG. 5 is a schematic representation of a computer system 200 of a type that is suitable for executing computer software that implements the metering and accounting schema 100. Computer software executes under a suitable operating system installed on the computer system 200, and may be thought of as comprising various software code means for achieving particular steps.

The components of the computer system 200 include a computer 220, a keyboard 210 and mouse 215, and a video display 290. The computer 220 includes a processor 240, a memory 250, input/output (I/O) interfaces 260, 265, a video interface 245, and a storage device 255.

The processor 240 is a central processing unit (CPU) that executes the operating system and the computer software executing under the operating system. The memory 250 includes random access memory (RAM) and read-only memory (ROM), and is used under direction of the processor 240.

The video interface 245 is connected to video display 290 and provides video signals for display on the video display 290. User input to operate the computer 220 is provided from the keyboard 210 and mouse 215. The storage device 255 can include a disk drive or any other suitable storage medium.

Each of the components of the computer 220 is connected to an internal bus 230 that includes data, address, and control buses, to allow components of the computer 220 to communicate with each other via the bus 230.

The computer system 200 can be connected to one or more other similar computers via a input/output (I/O) interface 265 using a communication channel 285 to a network, represented as the Internet 280.

The computer software may be recorded on a portable storage medium, in which case, the computer software program is accessed by the computer system 200 from the storage device 255. Alternatively, the computer software can be accessed directly from the Internet 280 by the computer 220. In either case, a user can interact with the computer system 200 using the keyboard 210 and mouse 215 to operate the programmed computer software executing on the computer 220.

Other configurations or types of computer systems can be equally well used to execute computer software that assists in implementing the techniques described herein.

Conclusion

Various alterations and modifications can be made to the techniques and arrangements described herein, as would be apparent to one skilled in the relevant art.

1. A system for monitoring and metering resource usage in a network, said system comprising:
an accounting manager component;
an administration manager component that supplies network-specific configuration information to said accounting manager component at runtime; and
at least one agent component to collect usage data from at least one managed resource connected to said network, and to report said collected usage data to said accounting manager component; and
wherein said accounting manager component meters usage data of said at least one managed resource by being configured at runtime to specific resource usage characteristics of said network based on said network-specific configuration information.

2. The system of claim 1, wherein said accounting manager component includes an accounting data schema that is configured at runtime based on said network-specific configuration information.

3. The system of claim 2, wherein said accounting data schema comprises monitoring, metering and accounting classes that are populated at runtime based on said network-specific configuration information.

4. The system of claim 1, wherein said administration manager component comprises a Graphical User Interface (GUI) to obtain said network-specific configuration information.

5. The system of claim 1, wherein said accounting manager component comprises an Application Programming Interface (API) for querying said accounting data schema.

6. The system of claim 1, wherein each said agent component comprises an accounting manager sub-component.

7. (canceled)

8. The system of claim 2, wherein said accounting data schema is implemented using a Common Information Model Object Manager (CIMOM).

9. A system for monitoring and metering resource usage in a network, said system comprising:
an accounting manager component including an accounting data schema comprising monitoring, metering and accounting classes adapted to be populated at runtime based on said network-specific configuration information;
an administration manager component that supplies network-specific configuration information to said accounting manager at runtime; and
at least one agent component adapted to collect usage data from at least one managed resource connected to said network, and to report said collected usage data to said accounting manager component; and
wherein said accounting manager component meters usage data of said at least one managed resource by being configured at runtime to specific resource usage characteristics of said network based on said network-specific configuration information.

10. A computer program product having a computer readable medium having a computer program recorded therein for monitoring and metering resource usage data in a network, said computer program comprising:
an accounting manager module to monitor and meter resource usage data in said network;
an administration module to supply network-specific configuration information to said accounting manager at runtime;
a database module to store resource usage data; and
at least one agent module to collect usage data from at least one managed resource connected to said network, said at least one agent module adapted to report said collected usage data to said accounting manager module; and
wherein said accounting manager module meters usage data of said at least one managed resource by being configured at runtime to specific resource usage characteristics of said network based on said network-specific configuration information.

11. The computer program product of claim 10, wherein said database module includes an accounting data schema that is configured at runtime based on said network-specific configuration information.

12. The computer program product of claim 11, wherein said accounting data schema comprises monitoring, metering and accounting classes adapted to be populated at runtime based on said network-specific configuration information.

13. The computer program product of claim 10, wherein said administration manager module comprises a Graphical User Interface (GUI) to obtain said network-specific configuration information.

14. The computer program product of claim 10, wherein said accounting manager module comprises an Application Programming Interface (API) for querying said accounting data schema.

15. The computer program product of claim 10, wherein said database module comprises an object-oriented database.

16. A computer program product having a computer readable medium having a computer program recorded therein for monitoring and metering resource usage data in a network, said computer program comprising:
an accounting manager module adapted to monitor and meter resource usage data in said network and including a data schema comprising monitoring, metering and accounting classes adapted to be populated at runtime based on said network-specific configuration information;
an administration module adapted to supply network-specific configuration information to said accounting manager at runtime;
at least one agent module to collect usage data from at least one managed resource connected to said network, said at least one agent module adapted to report said collected usage data to said accounting manager module; and
a database module to store resource usage data, said database module comprising an accounting data schema adapted to be configured at runtime based on said network-specific configuration information;
wherein said accounting manager module meters usage data of said at least one managed resource by being configured at runtime to specific resource usage characteristics of said network based on said network-specific configuration information.

17. The computer program product of claim 16, wherein said data schema comprises a metering record definition class having associations with a metering record value class, itself, said base metric definition class and said unit of work definition class.

18. A method for monitoring resource usage characteristics of a network, said method comprising:
generating a generic accounting data schema;
inputting network-specific configuration information relating to at least one managed resource connected to said network to said generic accounting data schema to generate a network-specific accounting data schema;
collecting network-specific resource usage data; and
storing said network-specific resource usage data in said network-specific accounting data schema.

19. A computer program product having a computer readable medium having a computer program recorded therein for monitoring and metering resource usage data in a network that, when executed, generates a data schema comprising:
a unit of work definition class having an association with a unit of work value class;
a base metric definition class having associations with a composite metric definition class and a base metric value class; and
a monitoring record definition class having associations with a monitoring record value class, said unit of work definition class, and said base metric definition class.

20. The computer program product of claim 19, further comprising
a metering record definition class having associations with a metering record value class, itself, said base metric definition class, and said unit of work definition class.

21. A method of deploying a resource accounting system in a network, said method comprising the:
deploying an accounting manager module, an administration module, and at least one agent module;
deploying a database;
creating a generic accounting data schema in said database adapted to store resource usage data;
inputting network-specific configuration information relating to at least one managed resource connected to said network; and
generating a network-specific accounting data schema based on said input network-specific configuration information.

22. A system for monitoring and metering resource usage in a network, said system comprising:
a memory unit for storing data and instructions; and
a processing unit coupled to said memory unit, said processing unit being programmed to:
generate a generic accounting data schema in a database;
obtain resource usage characteristics specific to said network; and populate said accounting data schema with data based on said obtained resource usage characteristics, wherein said system monitors and meters resource usage specific to said network.

23. The method of claim 18, further comprising using middleware to implement a system for performing said method.
